(19) United States
(12) Patent Application Publication
(10) Pub. No.: US 2026/0278029 A1
(43) Pub. Date: Sep. 17, 2026

(54) MICRO-FRONTENDS MANAGEMENT FOR A COMPOSABLE MODULAR PLATFORM

(71) Applicant: FAIR ISAAC CORPORATION, Minneapolis, MN (US)

(72) Inventors: Karissa Kay Kohn, North Saint Paul, MN (US); David Morris Berlin, Roseville, CA (US); Cameron John Foster Gray, Centeron, AR (US)

(21) Appl. No.: 19/077,547

(22) Filed: Mar. 12, 2025

(51) Int. Cl. G06F 16/958

(52) U.S. Cl. CPC G06F 16/958

(57) ABSTRACT

A computer-implemented method in a composable platform architecture, including: registering, by a micro-frontend (MFE) registration service, a MFE bundle and associated MFE metadata received from a MFE provider, the metadata describing at least a functionality, dependencies, and versioning of the MFE; storing, by an asset store, the MFE metadata, the asset store maintaining metadata records for registered MFEs to facilitate retrieval and management of MFE assets; querying, by a MFE discovery service, the asset store to retrieve metadata corresponding to one or more MFEs; composing a user experience by dynamically integrating the one or more MFEs based on the retrieved metadata; retrieving a MFE bundle associated with the one or more MFEs; and distributing, by a content delivery network (CDN), the retrieved MFE bundle to a user device for rendering within a client application.

### TECHNICAL FIELD

The subject matter described herein relates to architecture technology, specifically to systems and methods for composable modular platforms that manages and utilizes micro-frontend assets, enabling flexible and scalable user interfaces across various applications.

### BACKGROUND

In various industries, such as software development, e-commerce, and finance, building flexible and modular user interfaces is essential for adapting to rapidly changing user needs and business requirements. Traditional systems often rely on monolithic front-end architectures or tightly coupled modules, which create significant challenges when updates or changes are needed. This lack of flexibility can lead to delays in deploying new features, difficulty in maintaining code, and a higher risk of system-wide disruptions during updates.

Existing approaches to modularizing front-end applications often involve rigid frameworks that do not support independent deployment and updating of individual components. This leads to increased interdependencies, where changes to one component can necessitate alterations across the system. As a result, organizations struggle with maintaining adaptability and scalability, especially when responding to user demands or integrating new technologies. Moreover, these monolithic or semi-monolithic architectures tend to perform poorly under dynamic load conditions, as they require entire modules to load at once, impacting user experience and resource efficiency.

There is a need for a more advanced platform architecture that can enable modular, independently deployable components to be seamlessly integrated while maintaining interoperability and system stability. Such a platform would allow for a high degree of flexibility, enabling organizations to deploy and update specific front-end modules without affecting the entire system. This approach would support efficient resource usage, improve performance under dynamic conditions, and offer a user experience that is both responsive and adaptable to evolving requirements.

### SUMMARY

Methods, systems, and articles of manufacture, including computer program products, are provided for composable modular platforms that manages and utilizes micro-frontend assets. In another aspect, there is provided a computer-implemented method in a composable platform architecture, including: registering, by a micro-frontend (MFE) registration service, a MFE bundle and associated MFE metadata received from a MFE provider, wherein the metadata describes at least a functionality, dependencies, and versioning of the MFE; storing, by an asset store, the MFE metadata, wherein the asset store maintains metadata records for registered MFEs to facilitate retrieval and management of MFE assets; querying, by a MFE discovery service, the asset store to retrieve metadata corresponding to one or more MFEs; composing a user experience by dynamically integrating the one or more MFEs based on the retrieved metadata; retrieving a MFE bundle associated with the one or more MFEs; and distributing, by a content delivery network (CDN), the retrieved MFE bundle to a user device for rendering within a client application.

In some variations, the MFE metadata further includes path information associated with the MFE bundle, wherein the path information provides a link required to locate the MFE bundle.

In some variations, the method further includes dynamically resolving path information, by the MFE discovery service, wherein the MFE discovery service retrieves path information from the asset store.

In some variations, the method further includes selecting, by the MFE discovery service, a micro-frontend (MFE) based on introspection of the metadata, wherein the selection is dynamically performed in response to a user interaction to determine one or more appropriate MFE for rendering.

In some variations, the MFE metadata includes a versioning identifier, wherein based on the versioning identifier, the MFE discovery service selects a compatible MFE version to compose

In some variations, the asset store provides a centralized storage of metadata describing the functionality of a registered MFE to enable consistent retrieval, management, and governance of the MFE metadata across multiple services.

In some variations, the method further includes modifying, by the MFE registration service, an existing MFE metadata record upon receiving an update request from the MFE provider, wherein the update modifies the MFE metadata while preserving a version history.

In another aspect, there is provided a computer program product including a non-transitory computer readable medium storing instructions that, when executed by at least one programmable processor, cause the at least one programmable processor to perform operations. The operations include registering, by a micro-frontend (MFE) registration service, a MFE bundle and associated MFE metadata received from a MFE provider, wherein the metadata describes at least a functionality, dependencies, and versioning of the MFE; storing, by an asset store, the MFE metadata, wherein the asset store maintains metadata records for registered MFEs to facilitate retrieval and management of MFE assets; querying, by a MFE discovery service, the asset store to retrieve metadata corresponding to one or more MFEs; composing a user experience by dynamically integrating the one or more MFEs based on the retrieved metadata; retrieving a MFE bundle associated with the one or more MFEs; and distributing, by a content delivery network (CDN), the retrieved MFE bundle to a user device for rendering within a client application.

In another aspect, there is provided a system comprising: a programmable processor; and a non-transient machine-readable medium storing instructions that, when executed by the processor, cause the at least one programmable processor to perform operations. The operations include registering, by a micro-frontend (MFE) registration service, a MFE bundle and associated MFE metadata received from a MFE provider, wherein the metadata describes at least a functionality, dependencies, and versioning of the MFE; storing, by an asset store, the MFE metadata, wherein the asset store maintains metadata records for registered MFEs to facilitate retrieval and management of MFE assets; querying, by a MFE discovery service, the asset store to retrieve metadata corresponding to one or more MFEs; composing a user experience by dynamically integrating the one or more MFEs based on the retrieved metadata; retrieving a MFE bundle associated with the one or more MFEs; and distributing, by a content delivery network (CDN), the retrieved MFE bundle to a user device for rendering within a client application.

Implementations of the current subject matter can include, but are not limited to, methods consistent with the descriptions provided herein as well as articles that include a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary architecture of a micro-front end (MFE) platform 100, in accordance with one or more embodiments of the approach described herein.

FIG. 2 illustrates an exemplary architecture of a micro-front end (MFE) platform, in accordance with one or more embodiments of the approach described herein.

FIG. 3 is a diagram illustrating an exemplary architecture of a composable platform, in accordance with one or more embodiments of the present disclosure.

FIG. 4 is a diagram illustrating an exemplary process 400 for managing micro-frontends (MFEs) within a composable platform architecture, in accordance with one or more embodiments of the approach described herein.

FIG. 5 depicts a block diagram illustrating a computing system consistent with implementations of the current subject matter.

When practical, like labels are used to refer to same or similar items in the drawings.

### DETAILED DESCRIPTION

The details of one or more variations of the subject matter described herein are set forth in the accompanying drawings.

The present disclosure relates to a modular and composable platform architecture configured to facilitate integration across a plurality of business capabilities, including decisioning, analytics, optimization, and data management. This architecture is enabled by declarative protocols and flexible asset management. In some embodiments, the declarative protocols are those that set standardized rules for how assets interact within the platform, specifying interaction semantics, versioning, and compliance parameters to ensure seamless integration. The platform incorporates standardized protocol semantics, modular components, and multi-tenant management strategies to address complex business requirements, providing enhanced scalability and operability. Monolithic architectures typically experience significant strain on system resources due to tightly coupled dependencies, which can cause loading and response delays. In such systems, even minor updates can lead to cascading effects across multiple modules, creating bottlenecks and increasing deployment complexity. In some embodiments, the composable platform capability provides a foundational architecture for implementing declarative cross-cutting asset semantics to achieve flexible composition and standardized management of assets. This may include defining standardized interactions between assets, thereby enabling seamless integration of assets within the platform. The capability further includes a repository structure for asset storage and versioning, supporting multiple protocol versions to maintain compatibility between various iterations, thereby improving adaptability and scalability. The architecture may also facilitate flexible deployment of business function modules, enabling efficient management processes while maintaining high scalability. In some embodiments, the composable micro frontends capability implements a modular frontend architecture for the platform, utilizing micro frontends to build user interfaces. This capability may leverage declarative protocols and module federation to enable dynamic loading and composition of frontend components. The micro frontends capability further supports the loading and embedding of user interface components without necessitating a complete recompilation of the application, thus allowing for flexible customization and expansion of user interfaces. This architecture may enhance user experience by enabling the adjustment of frontend interactions according to specific requirements. In some embodiments, the multi-tenant capability provides strategies for managing multi-tenant environments and organizational hierarchies, allowing for secure and flexible asset management in multi-user settings. This capability may include defining hierarchical organizational structures that manage asset sharing and data isolation between tenants. It may further support tenant isolation to ensure the separation of data and business logic across different tenants, thus meeting data privacy and compliance requirements. Additionally, this capability may include configurable policies that support the customization of platform functionalities and access rights based on specific tenant requirements, facilitating adaptable and secure asset management in complex multi-tenant environments.

In some embodiments, declarative protocols establish standardized rules that automate and maintain interaction semantics across varying asset types within the platform. These protocols define interaction semantics to guide asset interactions through specific rules and configurations that support both consistency and adaptability. By abstracting the technical configurations necessary for asset integration, declarative protocols allow assets to interact seamlessly and autonomously without requiring significant manual configuration. This abstraction enables assets to adapt dynamically to new operational requirements while adhering to pre-established interaction conventions, thus promoting continuity as assets evolve over time. As new assets or functionality updates are introduced, declarative protocols provide a cohesive framework that aligns asset behavior with platform-wide standards, reducing the need for custom adjustments while maintaining operational integrity across the platform. Declarative protocols not only establish foundational rules for MFE interoperability but also support dynamic updates and synchronization across components. For example, declarative protocols enable the platform to seamlessly adjust and propagate version changes without requiring manual reconfiguration, thus preserving the stability and continuity of user interfaces as components evolve. In some embodiments, if the declared protocols themselves undergo changes, manual reconfiguration may be utilized to aid in compatibility.

The composable architecture strategy for the platform further enhances its adaptability by enabling highly flexible, modular integration of business capabilities into cohesive user journeys. This strategy emphasizes why the platform has chosen a composable approach to user interface (UI) construction, focusing on how this methodology benefits clients through a more customizable and responsive user experience. By implementing a structure that supports micro frontends (MFEs) as the primary building blocks, the platform enables users to achieve an experience that evolves in response to specific business needs and customer feedback, without the need for extensive system overhauls. This composable structure also reduces downtime by allowing MFEs to be updated or replaced independently. As a result, the platform can continuously evolve by integrating the latest features, based on user demands or technological advances, without disrupting existing workflows or requiring platform-wide updates. In some embodiments, this composable approach prioritizes a customer-centric design philosophy, allowing individual architecture services to develop and deploy their own MFEs independently. The platform's UI strategy leverages these MFEs to create user journeys that are inherently adaptable and capable of evolving incrementally. Each MFE can be built with the specific requirements of a particular business capability—such as decisioning, analytics, or optimization—while still integrating seamlessly within a unified UI framework. Each MFE operates as an autonomous unit, allowing independent deployment and configuration, which enables continuous updates without impacting other platform components. This independence aligns with the low-coupling, high-cohesion principle, allowing for incremental improvements to each MFE based on real-time user feedback or changes in business requirements.

The use of MFEs also enhances the platform's ability to provide business process personalization and dynamic composition for clients. This modularity enables clients to combine various MFEs into workflows that address their unique requirements, thereby allowing a high degree of customization without compromising system integrity. This composable architecture encourages a low-coupling, high-cohesion design, where different UI elements can interact through standardized protocols, allowing for continuous updates and iterative improvements that enhance the overall user experience. Through this approach, the platform can efficiently address clients' changing needs and maintain a user interface that remains aligned with architecture principles. This composable structure supports rapid iteration cycles, which improve client satisfaction and engagement by continuously delivering a UI that aligns closely with client goals and business demands. Each MFE operates as an autonomous unit, allowing independent deployment and configuration, which enables continuous updates without impacting other platform components. This independence aligns with the low-coupling, high-cohesion principle, allowing for incremental improvements to each MFE based on real-time user feedback or changes in business requirements.

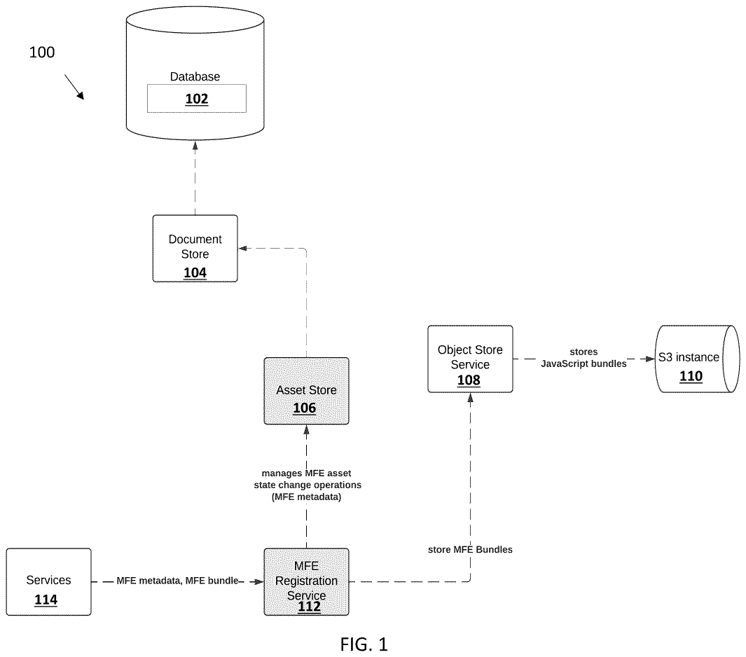

FIG. 1 illustrates an exemplary architecture of a micro-front end (MFE) platform 100, in accordance with one or more embodiments of the approach described herein. The MFE platform 100 facilitates the management, registration, storage, and retrieval of micro-front end assets, including metadata and JavaScript bundles. As depicted in FIG. 1, the MFE platform 100 includes multiple components that interact to support micro-front end functionality. A database 102 (which may be implemented as MongoDB) stores structured data related to the MFE platform, such as configuration settings, metadata, or other relevant information. A document store 104 may be utilized for storing unstructured or semi-structured data related to MFEs, such as logs, JSON metadata, or configuration files. In some embodiments, the document store 104 interacts with the database 102 to retrieve or persist information related to MFEs. An asset store 106 functions as a centralized storage of metadata describing the functionality of a registered MFE. In some embodiments, the asset store 106 may store information related to MFE configurations, operational parameters, dependencies, and versioning. The MFE registration service 112 enables services 114 (i.e., a MFE provider) to register MFE bundles and provide metadata describing how the MFE functions. In some embodiments, this service receives MFE metadata and MFE bundles from external services and facilitates their storage and management within the platform. The MFE registration service 112 transmits asset-related information to the asset store 106, which subsequently allows for metadata retrieval and usage by other components within the system. An object store service 108 serves as a repository for MFE-related assets, particularly MFE bundles, which may include JavaScript files. In some embodiments, this service interacts with external storage solutions to persistently store and retrieve assets as needed. The S3 instance 110 provides an external storage system where JavaScript bundles are stored. In some embodiments, the object store service 108 may upload or retrieve JavaScript bundles from the S3 instance 110 to facilitate micro-front end deployment and execution.

As shown in FIG. 1, services 114 (e.g., a MFE provider) may interact with the MFE registration service 112 to submit MFE metadata and bundles. The MFE registration service 112 enables the registration of MFE bundles and provides metadata describing how the MFE functions. The MFE registration service 112 may then transmit asset-related information to the asset store 106, which serves as a centralized storage of metadata describing the functionality of registered MFEs. The asset store 106 may communicate with the document store 104 and database 102 to store or retrieve relevant information. MFE bundles are stored in the object store service 108, which subsequently transfers JavaScript bundles to the S3 instance 110 for persistent storage. In some embodiments, the architecture depicted in FIG. 1 supports the modular deployment of micro-front ends by maintaining a structured approach to metadata management, versioning, and asset retrieval. The diagram highlights key components involved in managing MFE asset metadata, registration, and storage, ensuring a streamlined and organized system for handling micro-front end resources.

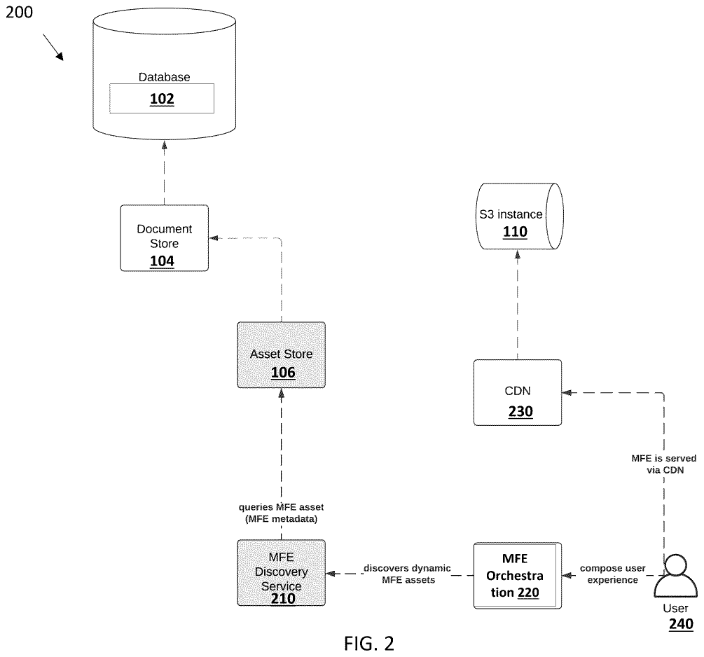

FIG. 2 illustrates an exemplary architecture of a micro-front end (MFE) platform 200, in accordance with one or more embodiments of the approach described herein. The MFE platform 200 enables the discovery, retrieval, and delivery of MFE assets to users by leveraging metadata storage, content distribution, and service-based composition of user experiences. As depicted in FIG. 2, the platform 200 includes multiple components that interact to support MFE discovery and delivery. A database 102 (which may be implemented as MongoDB) stores structured data related to MFE assets, including configurations, metadata, or other relevant information. A document store 104 may be utilized for storing unstructured or semi-structured data, such as logs, JSON metadata, or configuration files. In some embodiments, the document store 104 interacts with the database 102 to store and retrieve information associated with MFE assets. An asset store 106 functions as a centralized storage of metadata describing the functionality of registered MFEs. The asset store 106 may store information such as versioning details, dependencies, and operational parameters related to MFEs. A MFE discovery service 210 queries the asset store 106 to obtain metadata regarding available MFE assets. In some embodiments, the MFE discovery service 210 enables services to dynamically discover MFEs and retrieve relevant asset metadata. A MFE orchestration module 220 composes the user experience by integrating dynamically discovered MFE assets. This module interacts with the MFE discovery service 210 to retrieve available MFEs and construct a frontend experience based on the discovered components. Once a MFE asset is identified, its corresponding bundle may be fetched from storage. An S3 instance 110 provides an external storage system where JavaScript bundles of MFEs are stored. A content delivery network (CDN) 230 facilitates the efficient distribution of MFE assets to end users by caching and delivering JavaScript bundles from the S3 instance 110. In some embodiments, the CDN 230 accelerates the loading of MFE assets by serving cached versions to users, reducing latency and improving performance. A user 240 interacts with the composed frontend experience, which is dynamically assembled by MFE orchestration module 220 and delivered via the CDN 230. In some embodiments, the platform enables seamless updates to MFE assets by leveraging metadata retrieval, dynamic discovery, and distributed content delivery.

As shown in FIG. 2, the MFE discovery service 210 queries the asset store 106 to retrieve metadata about available MFEs. The MFE orchestration module 220 dynamically composes the user experience by integrating discovered MFEs. When a MFE asset is required, the corresponding JavaScript bundle is retrieved from the S3 instance 110 and delivered via the CDN 230 to optimize performance. The user 240 receives the composed MFE experience through the CDN 230. In some embodiments, the architecture depicted in FIG. 2 supports a dynamic and scalable approach to MFE deployment by enabling metadata-driven asset discovery, flexible service-based frontend composition, and efficient content delivery. The diagram highlights key components involved in managing MFE metadata, dynamic discovery, and seamless asset retrieval for delivering micro-front end experiences.

In some embodiments, the micro-front-end (MFE) platform described in FIG. 1 and FIG. 2 supports multiple types of MFEs that enable the composition of business capability user journeys. Specifically, the platform provides support for routable MFEs and embeddable MFEs, each serving distinct functions while contributing to the overall flexibility and modularity of the system. These MFEs adhere to platform standards to ensure seamless integration and interoperability. Routable MFEs, also referred to as authoring MFEs, are views provided by the client application's router. These MFEs typically offer extensive functionality, including support for child routes and pages. As they are accessed through dedicated routes, routable MFEs are generally not reusable across the platform, with users navigating directly to the specific route associated with a given MFE. The composition of user journeys in the platform often involves routing users to various authoring MFEs, which belong to the architecture service responsible for asset management. By directing users to the appropriate authoring MFEs, the platform achieves separation of concerns and minimizes coupling between architecture services. In some embodiments, architecture service MFE engineers utilize a routable protocol provided by the custodian architecture authoring API to retrieve the necessary data for dynamically constructing the correct route to an asset's authoring MFE. Examples of routable MFEs within the platform may include a Tree Authoring MFE and a Transactional Composition Authoring MFE. Embeddable MFEs, in contrast, are often designed as cross-cutting experiences that can be embedded within multiple views throughout the platform. These MFEs are identified through UX decomposition of business capability wireframes and are typically used to present contextualized asset information in different parts of a user journey. Unlike routable MFEs, embeddable MFEs are often single-component entities that do not include additional child routes. They are leveraged when specific cross-cutting concerns need to be displayed across various business capabilities. In some embodiments, embeddable MFEs are built responsively, ensuring that they dynamically adjust to the space allotted by the client's container. Examples of embeddable MFEs may include those that enable a user to select a Logical Schema for defining input/output variables or to view detailed asset data within a composition context. Another key aspect of embeddable MFEs is their role in enabling architecture services to provide a consistent interaction pattern across the platform for shared functionality. Architecture service MFE engineers may use an embeddable protocol provided by the custodian architecture service's API to retrieve the necessary MFE contract, which defines the configuration required for embedding these MFEs within other views. Both routable MFEs and embeddable MFEs adhere to platform-wide micro-frontend standards and are often provided by architecture service teams. In some embodiments, a business capability user journey is composed of multiple MFEs that either route users to different views or embed contextually relevant MFEs within a given page. Despite their similarities, these two types of MFEs differ in several key aspects. Routable MFEs typically provide broader functionality, may include child routes, and are accessed via direct navigation, whereas embeddable MFEs are lightweight, reusable components embedded within other views. Routable MFEs are less likely to be reused across the platform, while embeddable MFEs are designed for cross-platform reusability. Additionally, the composition of user journeys can involve routing between routable MFEs or embedding cross-cutting embeddable MFEs, depending on the use case. Architecture service engineers rely on the routable protocol for handling routable MFEs and the embeddable protocol for managing embeddable MFEs, ensuring proper integration and dynamic rendering of frontend components. In some embodiments, the approach described herein provides a structured and scalable method for integrating routable and embeddable MFEs into a unified user experience. By leveraging metadata-driven discovery, dynamic asset retrieval, and API-based protocol management, the platform facilitates modular frontend development while supporting the evolving needs of business capabilities.

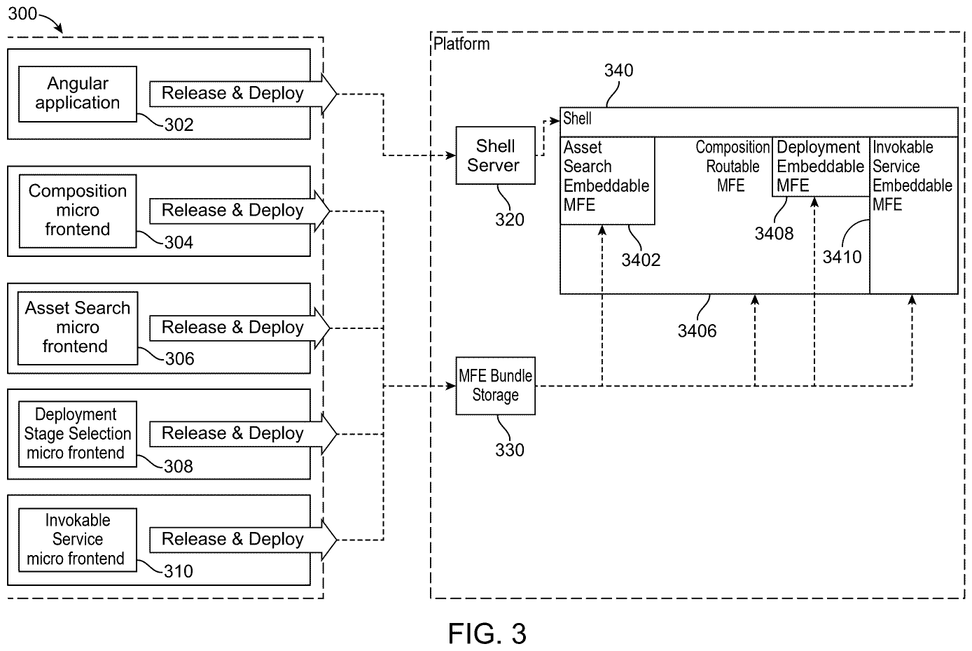

FIG. 3 is a diagram illustrating an exemplary architecture of a composable platform 300, in accordance with one or more embodiments of the present disclosure. As shown in FIG. 3, the composable platform 300 comprises an angular application 302, a composition MFE 304, an asset search MFE 306, a deployment stage selection MFE 308, an invokable service MFE 310, a shell server 320, a MFE bundle storage 330, and a shell 340.

In some embodiments, the angular application 302 is configured to directly connect with shell server 320, facilitating data exchange and enabling dynamic loading of MFEs based on user navigation and interactions. Composition MFE 304, asset search MFE 306, deployment stage selection MFE 308, and invokable service MFE 310 are communicatively linked to MFE bundle storage 330, allowing each MFE to retrieve necessary configuration data, components, and version-specific assets as required for their respective functions.

In some embodiments, the angular application 302 may provide a foundational UI framework to organize and manage micro frontends (MFEs) within the platform. It directly interfaces with the shell server 320 to render UI components, manage routing, and facilitate data exchanges across MFEs. The angular application 302 may be configured to dynamically load various MFEs based on user navigation and interactions, supporting a seamless and consistent user experience. The angular application 302 may also interact with shell 340, which serves as an intermediary layer containing various embedded and routable MFEs for specific functions. The Angular application dynamically loads and manages MFEs based on user-triggered events, facilitating a responsive and adaptable user interface within the platform.

The composition MFE 304 may operate as a core component for UI composition, arranging and embedding multiple MFEs to create an integrated user journey. Composition MFE 304 may retrieve and embed asset search MFE 306, deployment stage selection MFE 308, and invokable service MFE 310 from the MFE bundle storage 330. The composition MFE 304 is configured to communicate with MFE bundle storage 330 to retrieve the latest MFE versions for embedding purposes, allowing for updated functionality without impacting the overall user flow. Composition MFE 304 further connects indirectly with shell server 320 via the angular application 302, enabling smooth interactions and consistent data flow across embedded MFEs. The composition MFE retrieves version-specific configurations, ensuring each embedded MFE aligns seamlessly within the user's unified journey, enhancing contextual continuity across versions.

The asset search MFE 306, configured as an embeddable MFE, facilitates asset discovery through search and filtering functions. Asset search MFE 306 may access MFE bundle storage 330 to obtain configuration data and UI components necessary for executing search operations and rendering search results. Asset search MFE 306 integrates into the platform UI via shell 340, specifically as the asset search embeddable MFE 3402, enabling users to seamlessly access asset data within various business capability views. The asset search MFE retrieves version-specific resources, allowing for contextually relevant asset discovery based on user-defined criteria.

The deployment stage selection MFE 308, operating as an embeddable MFE, provides functionalities for configuring deployment stages, such as selecting target environments and specifying deployment parameters. Deployment stage selection MFE 308 may access MFE bundle storage 330 for version-specific configurations and deployable assets to offer users deployment options aligned with system compatibility. The deployment stage selection MFE 308 connects with shell 340 as deployment embeddable MFE 3408, supporting dynamic embedding within composition workflows managed by composition MFE 304. The deployment stage selection MFE accesses version-specific configurations, ensuring compatibility of deployment parameters within the current platform environment.

The invokable service MFE 310 provides service invocation functions, enabling users to trigger backend actions or retrieve service-specific data for selected assets. As an embeddable component, invokable service MFE 310 may interact with MFE bundle storage 330 to load necessary resources or service definitions, facilitating service interaction within the user journey. The invokable service MFE 310 integrates within shell 340 as invokable service embeddable MFE 3410, supporting the invocation of services in contexts where specific asset-related operations are required. Upon retrieving relevant data from the shell server, the invokable service MFE initiates backend service actions specific to the platform assets, ensuring accurate execution aligned with real-time data.

The shell server 320, which directly connects to angular application 302 and serves as the primary UI management layer, handles data exchange between the UI and backend resources, managing data flow consistency and routing requests across platform modules. In some embodiments, each MFE is configured to independently handle its own data exchange with backend services. The shell server 320 provides the underlying infrastructure for executing the angular application 302, wherein the MFEs, once federated into the shell application, include logic to directly communicate with their respective backend services without reliance on the shell server 320 for data mediation. In some embodiments, the shell server 320 acts as an intermediary for data flow management between the UI components and backend services, ensuring that all MFE interactions are synchronized with the latest data. By coordinating data exchange among MFEs, the shell server enhances real-time responsiveness and supports seamless transitions as users navigate between components. The angular application 302 may serve as a primary user interface, enabling access to shell server 320 functions and integrating shell 340 components within its UI structure. The Angular application and shell server establish and maintain communication links dynamically based on user interactions within the interface, facilitating seamless data exchange and routing for real-time responsiveness.

The MFE bundle storage 330 functions as a central repository, housing the MFE bundles for asset search MFE 306, composition MFE 304, deployment stage selection MFE 308, and invokable service MFE 310. In some embodiments, MFE bundle storage 330 provides version control and asset management, allowing MFEs to access and load version-specific data. MFE bundle storage 330 interfaces directly with individual MFEs, as specified in the platform's architecture, supporting modularity and streamlined component management.

Shell 340 comprises a structured collection of MFEs, including the asset search embeddable MFE 3402, composition routable MFE 3406, deployment embeddable MFE 3408, and invokable service embeddable MFE 3410. The asset search embeddable MFE 3402 provides search functionality, enabling users to discover assets based on defined criteria, while the composition routable MFE 3406 allows navigation across different business capability views, supporting user-directed workflows. The deployment embeddable MFE 3408 offers deployment configuration options as part of asset management workflows, and the invokable service embeddable MFE 3410 allows users to trigger backend services related to platform assets. Shell 340 serves as an integration layer for these MFEs, supporting modular embedding within the user interface and facilitating seamless, dynamic functionality across various business capabilities.

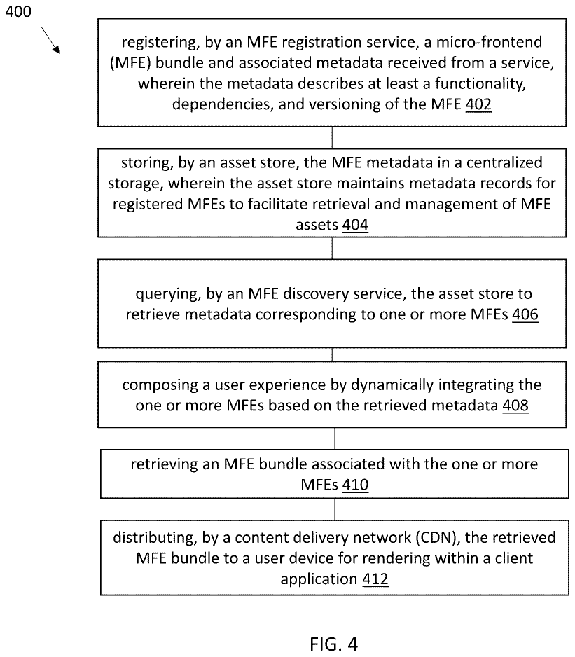

FIG. 4 is a diagram illustrating an exemplary process 400 for managing micro-frontends (MFEs) within a composable platform architecture, in accordance with one or more embodiments of the approach described herein. As shown in FIG. 4, the process 400 may begin with operation 402, wherein a micro-frontend (MFE) registration service registers a MFE bundle and associated MFE metadata received from a MFE provider. The MFE metadata describes at least a functionality, dependencies, and versioning of the MFE. Next, in operation 404, the MFE metadata is stored in an asset store, wherein the asset store maintains metadata records for registered MFEs to facilitate retrieval and management of MFE assets. In some embodiments, the asset store provides centralized metadata storage to enable consistent retrieval, management, and governance of MFE metadata across multiple services. The process 400 then proceeds to operation 406, wherein a MFE discovery service queries the asset store to retrieve metadata corresponding to one or more MFEs. In some embodiments, the MFE discovery service further retrieves path information associated with a MFE, wherein the path information provides a link required to locate the MFE. At operation 408, the system dynamically composes a user experience by integrating the one or more MFEs based on the retrieved metadata. In some embodiments, the MFE discovery service selects an appropriate MFE for rendering by performing introspection of the metadata in response to a user interaction. The process 400 advances to operation 410, wherein the system retrieves the MFE bundle associated with the one or more MFEs. In some embodiments, the retrieval process considers versioning information included in the MFE metadata, wherein based on the versioning identifier, the MFE discovery service selects a compatible MFE version to compose. At operation 412, the retrieved MFE bundle is distributed by a content delivery network (CDN) to a user device for rendering within a client application. In some embodiments, the CDN may prioritize caching of frequently accessed MFEs to optimize performance. In some embodiments, the system determines whether a MFE metadata update request has been received from a MFE provider. If an update request is received, the process proceeds and the MFE registration service modifies an existing MFE metadata record while preserving a version history. If no update request is received, or once the metadata update is completed, the process may end, or loop back to operation 402 for registering a new MFE. In some embodiments, dynamically resolving path information and querying the asset store to retrieve metadata may be performed iteratively during runtime to adjust the user experience dynamically in response to system conditions or user interactions. The process 400, as illustrated in FIG. 4, describes a structured approach for MFE registration, metadata management, MFE discovery, versioning, content distribution, and dynamic updates, ensuring efficient micro-frontend deployment and integration within a composable platform architecture.

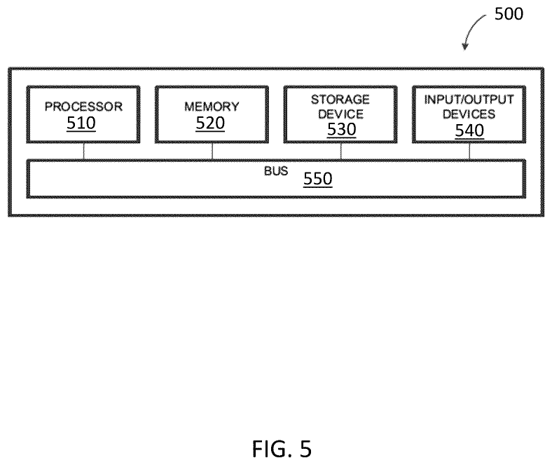

FIG. 5 depicts a block diagram illustrating a computing system 500 consistent with implementations of the current subject matter. As shown in FIG. 5, the computing system 500 can include a processor 510, a memory 520, a storage device 530, and input/output devices 540. The processor 510, the memory 520, the storage device 530, and the input/output devices 540 can be interconnected via a system bus 550. The computing system 500 may additionally or alternatively include a graphic processing unit (GPU), such as for image processing, and/or an associated memory for the GPU. The GPU and/or the associated memory for the GPU may be interconnected via the system bus 550 with the processor 510, the memory 520, the storage device 530, and the input/output devices 540. The memory associated with the GPU may store one or more images described herein, and the GPU may process one or more of the images described herein. The GPU may be coupled to and/or form a part of the processor 510. The processor 510 is capable of processing instructions for execution within the computing system 500. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540.

The memory 520 is a computer-readable medium, such as volatile or non-volatile memory, that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 1000 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in digital electronic circuitry, integrated circuitry, specially designed framework specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software frameworks, frameworks, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A computer-implemented method operating in a composable platform architecture, comprising:
registering, by a micro-frontend (MFE) registration service, a MFE bundle and associated MFE metadata received from a MFE provider, wherein the MFE metadata describes at least a functionality, dependencies, and versioning of the MFE;
storing, by an asset store, the MFE metadata, wherein the asset store maintains metadata records for registered MFEs to facilitate retrieval and management of MFE assets;
querying, by a MFE discovery service, the asset store to retrieve metadata corresponding to one or more MFEs;
composing a user experience by dynamically integrating the one or more MFEs based on the retrieved metadata;
selecting, by the MFE discovery service and based on the retrieved metadata, a MFE for rendering among the one or more MFEs in response to a user interaction with a client application;
retrieving a MFE bundle associated with the MFE selected for rendering; and
distributing, by a content delivery network (CDN), the retrieved MFE bundle to a user device for rendering within the client application.

2. The method of claim 1, wherein the MFE metadata further comprises path information associated with the MFE bundle, wherein the path information provides a link required to locate the MFE bundle.

3. The method of claim 1, further comprising dynamically resolving path information, by the MFE discovery service, wherein the MFE discovery service retrieves path information from the asset store.

4. (canceled)

5. The method of claim 1, wherein the MFE metadata comprises a versioning identifier, wherein based on the versioning identifier, the MFE discovery service selects a compatible MFE version to compose.

6. The method of claim 1, wherein the asset store provides a centralized storage of metadata describing the functionality of a registered MFE to enable consistent retrieval, management, and governance of the MFE metadata across multiple services.

7. The method of claim 1, further comprising:
modifying, by the MFE registration service, an existing MFE metadata record upon receiving an update request from the MFE provider, wherein the update modifies the MFE metadata while preserving a version history.

8. A computer program product operating in a composable platform architecture comprising a non-transient machine-readable medium storing instructions that, when executed by at least one programmable processor, cause the at least one programmable processor to perform operations comprising:
registering, by a micro-frontend (MFE) registration service, a MFE bundle and associated MFE metadata received from a MFE provider, wherein the MFE metadata describes at least a functionality, dependencies, and versioning of the MFE;
storing, by an asset store, the MFE metadata, wherein the asset store maintains metadata records for registered MFEs to facilitate retrieval and management of MFE assets;
querying, by a MFE discovery service, the asset store to retrieve metadata corresponding to one or more MFEs;
composing a user experience by dynamically integrating the one or more MFEs based on the retrieved metadata;
selecting, by the MFE discovery service and based on the retrieved metadata, a MEE for rendering among the one or more MFEs in response to a user interaction with a client application;
retrieving a MFE bundle associated with the MFE selected for rendering; and
distributing, by a content delivery network (CDN), the retrieved MFE bundle to a user device for rendering within the client application.

9. The computer program product of claim 8, wherein the MFE metadata further comprises path information associated with the MFE bundle, wherein the path information provides a link required to locate the MFE bundle.

10. The computer program product of claim 8, wherein the operations further comprise dynamically resolving path information, by the MFE discovery service, wherein the MFE discovery service retrieves path information from the asset store.

11. (canceled)

12. The computer program product of claim 8, wherein the MFE metadata comprises a versioning identifier, wherein based on the versioning identifier, the MFE discovery service selects a compatible MFE version to compose.

13. The computer program product of claim 8, wherein the asset store provides a centralized storage of metadata describing the functionality of a registered MFE to enable consistent retrieval, management, and governance of the MFE metadata across multiple services.

14. The computer program product of claim 8, wherein the operations further comprise:
modifying, by the MFE registration service, an existing MFE metadata record upon receiving an update request from the MFE provider, wherein the update modifies the MFE metadata while preserving a version history.

15. A system operating in a composable platform architecture comprising:
a programmable processor; and
a non-transient machine-readable medium storing instructions that, when executed by the processor, cause the at least one programmable processor to perform operations comprising:
registering, by a micro-frontend (MFE) registration service, a MFE bundle and associated MFE metadata received from a MFE provider, wherein the MFE metadata describes at least a functionality, dependencies, and versioning of the MFE;
storing, by an asset store, the MFE metadata, wherein the asset store maintains metadata records for registered MFEs to facilitate retrieval and management of MFE assets;
querying, by a MFE discovery service, the asset store to retrieve metadata corresponding to one or more MFEs;
composing a user experience by dynamically integrating the one or more MFEs based on the retrieved metadata;
selecting, by the MFE discovery service and based on the retrieved metadata, a MFE for rendering among the one or more MFEs in response to a user interaction with a client application;
retrieving a MFE bundle associated with the MFE selected for rendering; and
distributing, by a content delivery network (CDN), the retrieved MFE bundle to a user device for rendering within the client application.

16. The system of claim 15, wherein the MFE metadata further comprises path information associated with the MFE bundle, wherein the path information provides a link required to locate the MFE bundle.

17. The system of claim 15, wherein the operations further comprise dynamically resolving path information, by the MFE discovery service, wherein the MFE discovery service retrieves path information from the asset store.

18. (canceled)

19. The system of claim 15, wherein the MFE metadata comprises a versioning identifier, wherein based on the versioning identifier, the MFE discovery service selects a compatible MFE version to compose.

20. The system of claim 15, wherein the asset store provides a centralized storage of metadata describing the functionality of a registered MFE to enable consistent retrieval, management, and governance of the MFE metadata across multiple services.
